(19) United States
(12) Patent Application Publication
(10) Pub. No.: US 2026/0001753 A1
(43) Pub. Date: Jan. 1, 2026

(54) BEVERAGE CONTAINER PIERCING DEVICE

(71) Applicant: Shane Lucas Smith, Bellbrook, OH (US)

(72) Inventor: Shane Lucas Smith, Bellbrook, OH (US)

(21) Appl. No.: 19/275,084

(22) Filed: Jul. 21, 2025

Related U.S. Application Data
(63) Continuation of application No. 18/378,640, filed on Oct. 10, 2023, now Pat. No. 12,384,669.
(60) Provisional application No. 63/378,881, filed on Oct. 9, 2022.

(51) Int. Cl. B67B 7/86

(52) U.S. Cl. CPC B67B 7/28

(57) ABSTRACT

A drinking apparatus comprises a main body, a moveable spout, a piercing mechanism, and a rotatable bottom piece. The main body comprises a housing for holding a beverage container, and a side channel extending radially from the housing. The moveable spout transitions between an extended position and a retracted position along the side channel. Further, the piercing mechanism couples to the moveable spout such that when the moveable spout is in the retracted position, the piercing mechanism is within the housing. Also, the rotatable bottom piece is configured to selectively transition the moveable spout from the extended position to the retracted position.

### RELATED APPLICATIONS

This application claims priority to U.S. patent application Ser. No. 18/378,640 entitled BEVERAGE CONTAINER PIERCING DEVICE, filed Oct. 10, 2023 by Shane Lucas Smith, which claims priority to U.S. provisional patent application Ser. No. 63/378,881, entitled BEVERAGE CONTAINER PIERCING DEVICE, filed on Oct. 9, 2022, which is co-pending, the entireties of which are hereby incorporated by reference.

### BACKGROUND OF THE INVENTION

Drinking beer or other liquid rapidly through a hole punctured in the bottom of an aluminum beverage can is a practice commonly referred to as “shotgunning.” “Shotgunning” a beer or other liquid involves piercing a hole in the bottom section of an aluminum can, then opening the can using the pull tab, and finally, quickly consuming the beverage through the hole poked in the bottom of the can. The hole in the can is typically made with a sharp object like a car key, a knife, or a can-opener. This practice is typically done in a group of people, with participants racing to see who can drink the beer or other liquid the fastest. It is usually viewed as a drinking game or party activity. This common game can be improved using modern methods to facilitate the piercing of the can and the nature of the way the game itself is played.

### SUMMARY OF THE INVENTION

The present subject matter relates to a device that punctures a beverage can containing liquid, allowing the contents to flow quickly from the can for the user of the device to consume. In its preferred embodiment, the device is used in the context of a game. Participants in the game take turns passing the device between participants until the device punctures the can of liquid, and the final participant consuming the entire contents of the can.

In its preferred method of use, the game is played as follows: The first player holds the device with one hand and pulls the movable spout. The spout moves outward from the main circular body of the device until it is locked into its extended position. The same player then inserts their canned beverage of choice completely inside the main body of the device. The device has now been prepared and loaded, and the game is ready to begin. The first player begins the game by holding the device upright, and twisting the bottom, rotating base of the device counterclockwise until exactly one audible clicking noise can be heard coming from inside the device. The first player ceases to twist the rotating base of the device and passes the device to the next player. The next player then turns the rotating base of the device in the same direction as the first player, until exactly one audible click is produced by the device. Play continues in this fashion, with each player proceeding to twist the rotating base of the device producing an audible click which ends their turn. Eventually, one player will twist the rotating base and cause the spout to quickly withdraw inward towards the center of the device, into its retracted position. This player is known as the Loser. This rapid retraction of the spout causes the beverage can to be punctured by the pointed tip of the movable spout. The beverage inside the can quickly begins pouring out of the hole in the movable spout, via the circular channel of the main body. To facilitate a faster rate of flow of the liquid, the Loser who triggers the spout to puncture the can then opens the top of the can via the pull tab or other available method. Once the liquid is flowing quickly from the spout, the loser “shotguns”, or drinks as quickly as possible, the liquid as fast as they can, until the can is empty. Once the loser has consumed as much liquid from the can as they are able, the game ends. The losing player, or another player then pulls the movable spout again locking it into its extended position. This causes the pointed tip of the spout to exit the empty beverage can. The empty beverage can is then able to be removed from the main body of the device. Once the empty beverage can has been removed from the device, a full beverage can is able to be re-inserted into the main body of the device, and the game can begin again. If the players no longer wish to play the game, the spout can be triggered into its retracted position by twisting the rotating base by as many clicks as are necessary to retract the movable spout.

The intention of the game is to have the rotating base of the device produce a seemingly random number of audible clicks from the beginning of the game, until the beverage can is punctured, every time the game is played. The method of producing the seemingly random number of clicks is discussed below.

The game can be played in many different methods other than the preferred method as described above. One example of a variation on the way the game is played is as follows: Instead of each player twisting the rotating base of the device until only one audible click is heard, each player may throw a six-sided dice before their turn begins, and proceed to produce an audible number of clicks equal to the resulting number shown on the dice.

Other features and advantages of the present invention will become apparent to the reader upon reading the following detailed description, when considered in conjunction with the accompanying drawings.

### BRIEF DESCRIPTION OF THE DRAWINGS

FIG. 1 is an upper perspective view of an embodiment of the device.

FIG. 2 is a side perspective view of an embodiment of the device.

FIG. 3 is a lower perspective view of an embodiment of the device.

FIG. 4 is an upper perspective view of an embodiment of the device with a beverage container inserted into the device.

FIG. 5 is a side perspective view of an embodiment of the device with a beverage container inserted into the device.

FIG. 6 is a lower perspective view of an embodiment of the device with a beverage container inserted into the device.

FIG. 7 is a half section side view of an embodiment of the device with the movable spout in its extended position. This view shows an embodiment of the device with the liquid containing beverage can inserted into the main body of the device.

FIG. 8 is a half section side view of an embodiment of the device with the movable spout in its retracted position. This view shows an embodiment of the device with the liquid containing beverage can inserted into the main body of the device.

FIG. 9 is a half section side view of an embodiment of the device with the movable spout in its extended position. This view shows an embodiment of the device without the liquid containing beverage can inserted into the main body of the device.

FIG. 10 is a half section side view of an embodiment of the device with the movable spout in its retracted position. This view shows an embodiment of the device without the liquid containing beverage can inserted into the main body of the device.

FIG. 11 is an upper perspective view of an embodiment of the rotating bottom piece.

FIG. 12 is a lower perspective view of an embodiment of the rotating bottom piece.

FIG. 13 is an upper front perspective view of an embodiment of the movable spout.

FIG. 14 is a lower rear perspective view of an embodiment of the movable spout.

FIG. 15 is an upper perspective view of the bottom of an embodiment of the main body.

FIG. 16 is an upper perspective view of an embodiment of the spring plate.

FIG. 17 is a side perspective half section view of an embodiment of the spring plate and its interaction with the rotating bottom piece.

### DETAILED DESCRIPTION OF THE DRAWINGS

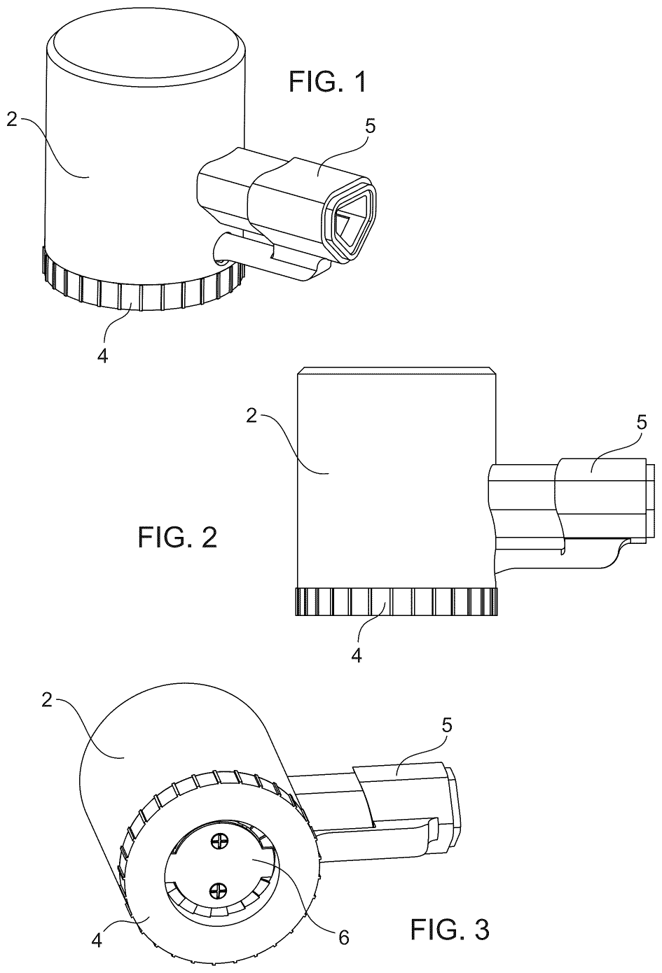

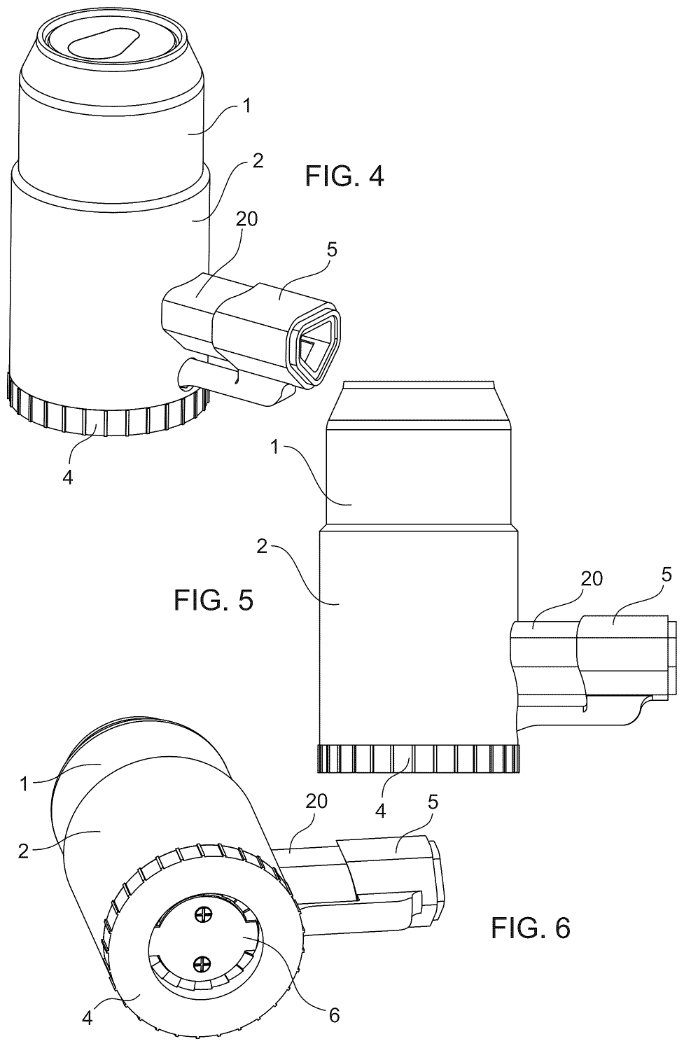

FIGS. 1 through 10 illustrate a beverage container piercing device in accordance with the present subject matter. The device includes main body 2 having a generally circular perimeter and side channel 20 having a generally triangular perimeter. The primary purpose of main body 2 is to house the beverage container 1. The secondary purpose of main body 2 is to facilitate the flow of liquid from the beverage container 1 through channel 20, and movable spout 5.

Main body 2 may be fabricated from several different materials and present in several different sizes. The main purpose of main body 2 is to contain beverage container 1. Beverage container 1 may come in several different sizes. Main body 2 may be fabricated in any size that will facilitate smaller or larger beverage containers. In its preferred embodiment, main body 2 is composed of plastic, but it also may be made of metal, ceramic, or any other material that would serve the purpose of housing a beverage container in a sturdy cylindrical housing.

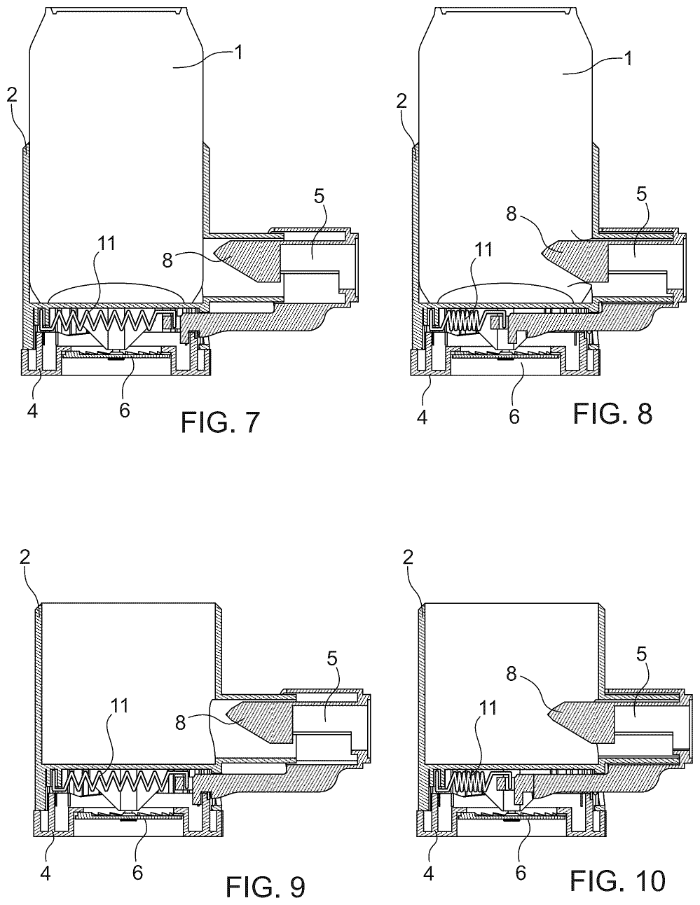

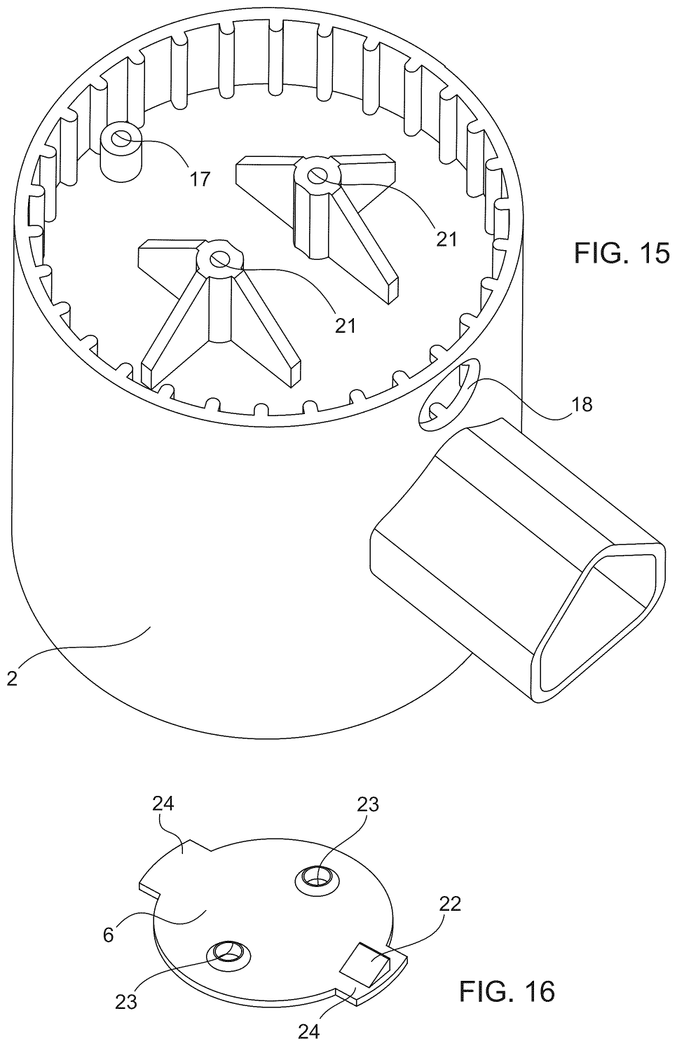

The beverage container piercing device, in accordance with the present subject matter also includes movable spout 5. Movable spout 5 can be seated in two positions. Movable spout 5 can be seated in its extended position, FIG. 7 and FIG. 9, and its retracted position, FIG. 8 and FIG. 10. Movable spout 5, depicted in detail in FIG. 14, consists of a generally triangular spout, with hole 16 intended for the flow of liquid from beverage container 1. Movable spout 5, depicted in detail in FIG. 13, also includes holding notch 15, piercing end 8, and spring seat 14. Piercing end 8 is intended to pierce beverage container 1, allowing for the flow of liquid to begin. Piercing end 8 can be embodied in a variety of different shapes. In the preferred embodiment, piercing end 8 is generally shaped like a pointed cone. The pointed cone shape allows for an easy penetration of beverage container 1. The cone shape also allows for a large enough hole to be pierced through the beverage container to allow for the flow of liquid. The pointed end may be embodied in many different shapes sufficient to pierce a beverage container while still allowing liquid to flow around the pointed end while it is still inserted into the beverage container. The pointed cone shape may be solid or hollow. The pointed end may also be made of many different materials. The pointed end may be made of plastic, metal, ceramic, or any other material sufficient to pierce beverage container 1. There may be a gasket material placed between movable spout 5 and main body 2 to prevent spilling of liquid.

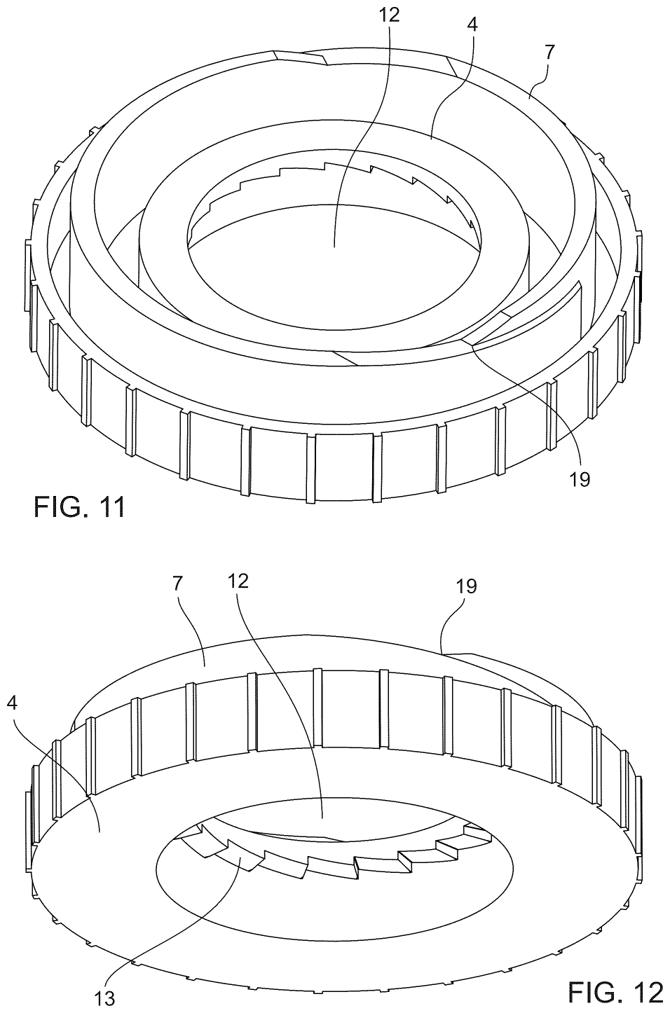

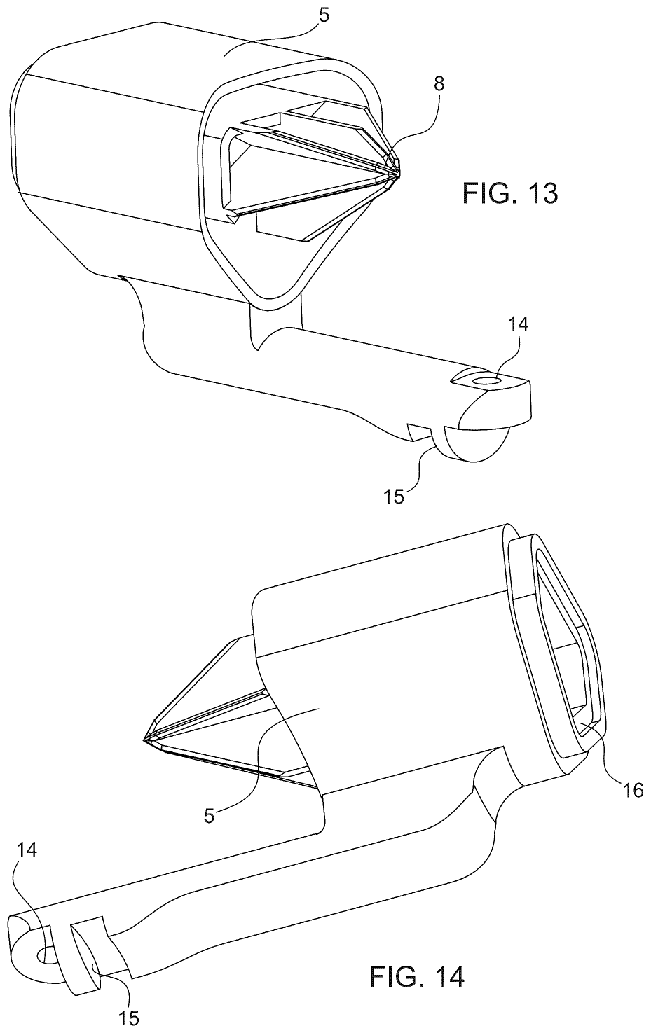

On the bottom of main body 2, depicted in detail in FIG. 15, is rear end spring holder 17, screw bosses 21, and channel 18. The bottom of main body 2 includes channel 18 for movable spout 5. Movable spout 5 slides along channel 18. The bottom of main body 2 is also composed of rear end spring holder 17. Rear end spring holder 17 is intended to hold tension spring 11 to main body 2. A screw may be inserted into rear end spring holder 17 to secure spring 11. The other end of tension spring 11 is held within movable spout 5 and spring seat 14. When movable pour spout 5 is pulled to its extended position, FIGS. 7 and 9, tension spring 11 holds tension between movable pour spout 5 and main body 2. When in its extended position, the tension caused by tension spring 11 between main body 2 and movable spout 5 is held in position by ridge 7 on rotating bottom piece 4 depicted in FIG. 11 and FIG. 12. Ridge 7 holds movable spout 5 in its extended position by seating itself into notch 15 in movable spout 5 until it is released into its retracted position caused by the rotation of rotating bottom piece 4. Movable spout 5 is released rapidly into its retracted position when notch 19 in rotating bottom piece 4 aligns itself axially with notch 15 in spout 5.

Rotating bottom piece 4, which contains ridge 7, is held in upward compression by spring plate 6, depicted in detail in FIG. 16. Spring plate 6 is comprised of a thin, flexible material. Spring plate 6 is held in place by 2 screws, using screw holes 23. The screws are fastened into bosses 21 in the main body 2. Spring plate 6 applies upward force to rotating bottom piece 4 via flaps 24 while still allowing it to extend downward when a downward force is applied to spring plate 6. This mechanism allows rotating bottom piece 4 to rotate axially around spring plate 6 as well as to temporarily extend downward when a downward force is applied. This downward force extension is necessary for function of click mechanism 22 and for seating ridge 7 of rotating bottom piece 4, into holding notch 15 of movable spout 5. The purpose of spring plate 6 is to ensure that rotating bottom piece 4 remains in contact with main body 2, while also allowing it to freely spin, to produce a clicking sound and also trigger movable spout 5 into its retracted position.

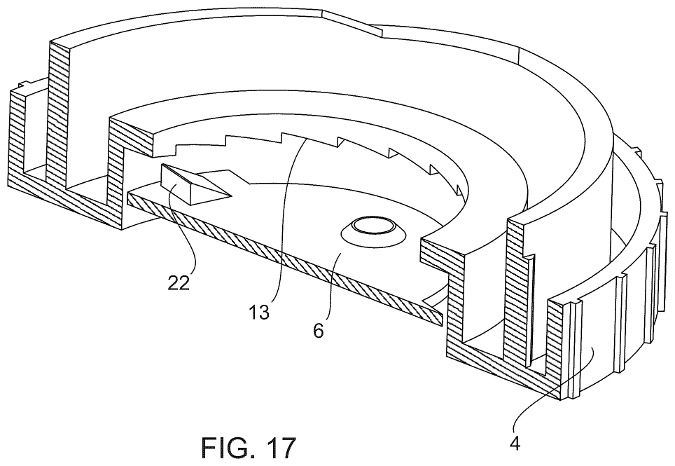

Rotating bottom piece 4 is depicted in detail in FIG. 11, FIG. 12 and FIG. 17. Rotating bottom piece 4 comprises wedges 13, ridge 7, and notch 19. During gameplay, rotating bottom piece 4 rotates around its center axis 12. Wedges 13 are intended to produce the audible click when the users are playing the game through their interaction with click mechanism 22 on spring plate 6. Notch 19 is intended to release movable spout 5 from its extended position to its retracted position. As rotating bottom piece 4 is rotated counterclockwise, notch 19 slowly aligns with notch 15 to release pour spout 5 into its retracted position, thus piercing the beverage container. Rotating bottom piece 4 may have any number of notches 19. The number of notches 19, and the number of wedges 13 between notches 19, determines the effect of the apparent random nature of the device. Rotating bottom piece 4 may be rotated by hand in its preferred embodiment or facilitated via another method like a push button or lever arm, like a slot machine. These features may be incorporated into main body 2 of the device. When rotated counterclockwise, rotating bottom piece 4 produces an audible clicking sound every time wedge 13 passes by click mechanism 22, depicted in FIG. 17. Click mechanism 22 is composed of a wedge that produces a clicking sound when wedge 13 passes by it during its rotation while playing the game. Click mechanism 22 also prevents rotating bottom piece 4 from rotating in the wrong direction through its interaction with wedges 13.

While best mode of the present invention has been illustrated and described in detail, it is to be understood that numerous modifications can be made to embodiments of the present invention without departing from the spirit thereof.

What is claimed is:

1. A drinking apparatus comprising:
a main body comprising:
a housing for holding a beverage container; and
a side channel extending radially from the housing;
a moveable spout that transitions between an extended position and a retracted position along the side channel;
a piercing mechanism coupled to the moveable spout such that when the moveable spout is in the retracted position, the piercing mechanism is within the housing; and
a rotatable bottom piece configured to selectively transition the moveable spout from the extended position to the retracted position.

2. The drinking apparatus of claim 1, further comprising:
a spring coupled to the moveable spout, such that when the moveable spout is in the extended position, the spring holds a force between the moveable spot and the main body;
wherein:
the rotatable bottom piece includes a mechanism to prevent the moveable spout from transitioning from the extended position to the retracted until the rotatable bottom piece is rotated.

3. The drinking apparatus of claim 2, wherein the spring is a tension spring.

4. The drinking apparatus of claim 3, wherein:
the moveable spout includes a notch; and
the mechanism to prevent the moveable spout from transitioning from the extended position includes a ridge that fits into the notch of the moveable spout to prevent the moveable spout from transitioning from the extended position.

5. The drinking apparatus of claim 4, wherein:
the ridge includes a notch such that when the notch of the ridge aligns with the notch of the moveable spout due to rotation of the rotatable bottom piece, the moveable spout transitions from the extended position to the retracted position.

6. The drinking apparatus of claim 4, wherein:
the ridge is held upward to engage the notch of the moveable spout by a spring plate.

7. The drinking apparatus of claim 1, further comprising a spring plate including a click mechanism;
wherein the rotatable bottom piece includes wedges that engage with the click mechanism of the spring plate as the rotatable bottom piece is rotated.
